(19) United States
(12) Patent Application Publication
(10) Pub. No.: US 2005/0265285 A1
(43) Pub. Date: Dec. 1, 2005

(54) Method and medium for handing over mobile nodes between service areas of wireless LAN and wired LAN

(75) Inventors: Jung-hoon Cheon, Suwon-si (KR); Youn-hee Han, Guri-si (KR); Xiaoyu Liu, Yongin-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/131,201

(22) Filed: May 18, 2005

Related U.S. Application Data
(60) Provisional application No. 60/573,843, filed on May 25, 2004.

(30) Foreign Application Priority Data
Jan. 21, 2005 (KR) 2005-5777

(51) Int. Cl. H04Q 7/00

(52) U.S. Cl. 370/331

(57) ABSTRACT

A handover method and medium of a mobile node that moves between service areas of wireless LAN and wired LAN. The mobile node carries out semi-soft handover when moving from the service area of the wireless LAN to that of the wired LAN. The mobile node carries out soft handover when moving from the service area of the wired LAN to that of the wireless LAN. Therefore, the mobile node can communicate over the wireless LAN or the wired LAN without data interruption.

### CROSS-REFERENCE TO RELATED APPLICATIONS

This application claims the benefits from U.S. Provisional Application No. 60/573,843 filed on May 25, 2004 in the United State Patent and Trademark Office and Korean Patent Application No. 2005-05777 filed on Jan. 21, 2005 in the Korean Intellectual Property Office, the entire disclosures of which are incorporated herein by reference.

### BACKGROUND OF THE INVENTION

1. Field of the Invention

The present invention relates generally to a handover method between a wired local area network (LAN) and a wireless LAN. More specifically, the present invention relates to a method enabling a mobile node linkable to a wireless LAN or a wired LAN to be handed between the two LANs with seamless data communication.

2. Description of the Related Art

Internet connection by use of a wired local area network (LAN), which is employed in office buildings or schools, is changing to a wireless communication by means of a wireless LAN of IEEE 802.11, Bluetooth, or an infrared transmission. The wireless LAN is also referred to as a Wi-Fi in a sense that the wireless LAN facilitates the wireless network like a high-fidelity audio. The wireless LAN enables very high speed Internet communication via a personal digital assistant (PDA) or a notebook computer located within a specific range from an access point (AP). While the wireless LAN, using radio resources, does not require a telephone line or a leased line, a wireless LAN card should be installed in a PDA or a notebook computer. The wireless LAN covered only about 10 m at an initial phase, but extended its coverage to substantially 50˜200 m in 2000's. Transmission rate in the wireless LAN is about 4˜11 Mbps, enough to transceive multimedia information of high capacity.

As above, as the wireless LAN of the IEEE 802.11 and the wired LAN of the IEEE 802.3 are deployed in office buildings or schools, a mobile node can link to one of the wireless LAN or the wired LAN network. Hence, it is required that the mobile node should be handed over smoothly while moving into and out of service areas of the wireless LAN and the wired LAN. Types of the handover are explained below.

The types of the handover include a hard handover, a soft handover, and a semi-soft handover. In the hard handover, a mobile node to be handed over removes a link to a current network and establishes a link to a new network. In the soft handover, the mobile node maintains the current link to the old network and attempts to set up a link to a new network. That is, the soft handover removes the link to the old network after establishing the link to the new network. The semi-soft handover, an intermediate type between the hard handover and the soft handover, maintains the link to the current network while conducting a part of procedures to set up a link to a new network. In other words, the semi-soft handover removes the link to the current network after carrying out a part of the procedures to establish the link to the new network.

In general, the soft handover is characterized by a seamless handover during the data transmission and reception, but may waste radio resources to establish a link to a new network for the sake of handover. The hard handover can reduce waste of the radio resources, but may interrupt the data transmission and reception.

FIG. 1 depicts a service area 100 of the wired LAN of the IEEE 802.3, a service area 102 of the wireless LAN of the IEEE 802.11, and a mobile node (MN) 110 linkable to both the wired LAN and the wireless LAN. The MN 110 includes a wireless interface for data transmission and reception in the wireless LAN, and a wired interface for data transmission and reception in the wired LAN.

In FIG. 1, the MN 110, which is linked to the wired LAN and communicates data, moves into the service area 102 of the wireless LAN. The mobile node 110 needs to be handed from the service area 100 of the wired LAN to the service area 102 of the wireless LAN without interrupting the data transmission and reception. It is noted that the smooth handover without the data interruption is required when the MN 110 moves from the service area 102 of the wireless LAN to the service area 100 of the wired LAN. Accordingly, a need arises to carry out the smooth handover between the service areas of the wired LAN and the wireless LAN.

### SUMMARY OF THE INVENTION

The present invention has been provided to solve the above-mentioned and other problems and disadvantages occurring in the conventional arrangement, and an aspect of the present invention provides a method for conducting smooth handover at a mobile node operable to communicate over a wireless local area network (LAN) and a wired LAN.

Another aspect of the present invention provides a method for enhancing data reliability through smooth handover between service areas of a wireless LAN and a wired LAN.

To achieve the above aspects and/or features of the present invention, a handover method of a mobile node that moves from a service area of a wired local area network (LAN) to a service area of a wireless LAN includes accessing an active access point (AP) using information relating to the active access point stored in the mobile node when breakage of a link to the wired LAN is detected; and communicating with the active AP using a temporary address assigned from the connected active AR

The mobile node configures and stores an Internet protocol (IP) address, which is used to access the active AR The mobile node may update binding when the assigned temporary address is different from a temporary address used in the wired LAN.

The active AP, among APs in the wireless LAN, has a communication state, which is determined to be qualified by the mobile node. The communication state is measured by at least one of a ratio of a received power to a transmitted power, and the received power to determine that the communication state qualifies as the active AR

The mobile node may be handed from the service area of the wired LAN to the service area of the wireless LAN according to a semi-soft handover.

Consistent with the above aspects of the present invention, a handover method of a mobile node that moves from a service area of a wireless local area network (LAN) to a service area of a wired LAN, includes configuring an Internet protocol (IP) address for the wired LAN when the mobile node keeping a link to an active access point (AP) detects connection to the wired LAN; and communicating over the wired LAN using a temporary address assigned corresponding to the IP address.

The mobile node may be handed over from the service area of the wireless LAN to the service area of the wired LAN according to a soft handover. The binding may be updated when the temporary address is different from a temporary address used in the wireless LAN. The mobile node may be assigned a temporary address using a pre-configured IP address for the wired LAN when a link to the wired LAN is detected.

To achieve the above aspects and/or features of the present invention, a handover method of a mobile node that moves between a service area of a wireless local area network (LAN) and a service area of a wired LAN, includes determining whether the handover is requested; and moving, when the handover is requested, to the service area of the wired LAN according to a soft handover when a current service area is the service area of the wireless LAN, and moving to the service area of the wireless LAN according to a semi-soft handover when the current service area is the service area of the wired LAN.

The soft handover may include configuring an Internet Protocol (IP) address for the wired LAN when the mobile node, keeping a link to an active access point (AP), detects connection to the wired LAN; and communicating over the wired LAN using an assigned temporary address corresponding to the IP address.

The semi-soft handover may include accessing an active AP using information relating to the active AP stored in the mobile node when breakage of a link to the wired LAN is detected; and communicating with the active AP using a temporary address assigned form the connected active AP.

At least one computer readable medium storing instructions that control at least one processor to perform a handover method of a mobile node that moves from a service area of a wired local area network (LAN) to a service area of a wireless LAN, including accessing an active access point (AP) using information relating to the active AP stored in the mobile node when breakage of a link to the wired LAN is detected; and communicating with the active AP using a temporary address assigned from the connected active AP.

At least one computer readable medium storing instructions that control at least one processor to perform a handover method of a mobile node that moves from a service area of a wireless local area network (LAN) to a service area of a wired LAN, including configuring an Internet Protocol (IP) address for the wired LAN when the mobile node, keeping a link to an active access point (AP), detects connection to the wired LAN; and communicating over the wired LAN using an assigned temporary address corresponding to the IP address.

At least one computer readable medium storing instructions that control at least one processor to perform a handover method of a mobile node that moves between a service area of a wireless local area network (LAN) and a service area of a wired LAN, including determining whether the handover is requested; and moving, when the handover is requested, to the service area of the wired LAN according to a soft handover when a current service area is the service area of the wireless LAN, and moving to the service area of the wireless LAN according to a semi-soft handover when the current service area is the service area of the wired LAN.

The at least one computer readable medium may have a soft handover including configuring an Internet protocol (IP) address for the wired LAN when the mobile node, keeping a link to an active access point (AP), detects connection to the wired LAN; and communicating over the wired LAN using an assigned temporary address corresponding to the IP address.

The at least one computer readable medium may have the semi-soft handover including accessing an active AP, which is stored in the mobile node, when breakage of a link to the wired LAN is detected; and communicating with the active AP using a temporary address assigned from the connected active AP.

The active AP may be in a communication state which is qualified by the mobile node.

### BRIEF DESCRIPTION OF THE DRAWINGS

These and/or other aspects and advantages of the invention will become apparent and more readily appreciated from the following description of exemplary embodiments, taken in conjunction with the accompanying drawing figures of which:

FIG. 1 illustrates a mobile node moving from a service area of a wired LAN to that of a wireless LAN;

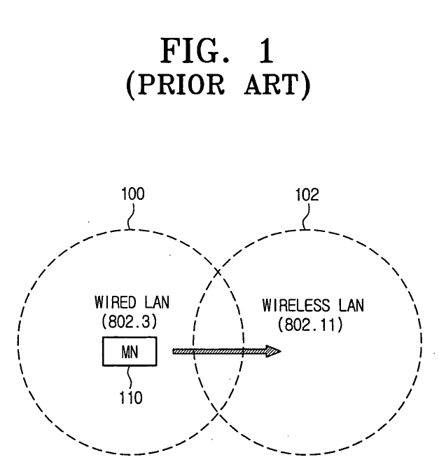

FIG. 2 is a flowchart illustrating operations of a mobile node before conducting handover, according to an exemplary embodiment of the present invention;

FIG. 3 is a flowchart illustrating operations of the node handed from a service area of a wired LAN to that of a wireless LAN, according to an exemplary embodiment of the present invention; and

FIG. 4 is a flowchart illustrating operations of the mobile node handed from the service area of the wireless LAN to that of the wired LAN, according to an exemplary embodiment of the present invention.

### DETAILED DESCRIPTION OF THE PREFERRED EMBODIMENTS

A method for conducting smooth handover at a mobile node, which communicates data over a wireless local area network (LAN) and a wired LAN, according to exemplary embodiments of the present invention, will now be described in greater detail with reference to the accompanying drawings.

In the following description, same drawing reference numerals are used for the same elements even in different drawings. The matters defined in the description, such as detailed construction and element descriptions, are provided to assist in a comprehensive understanding of the invention. Also, well-known functions or constructions are not described in detail since they would obscure the invention in unnecessary detail.

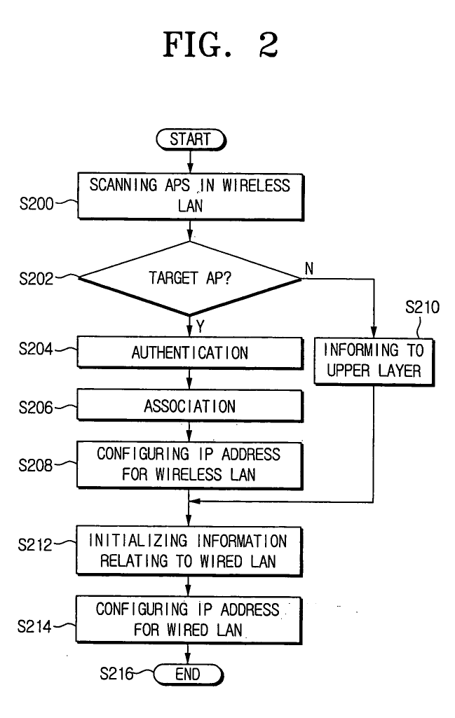

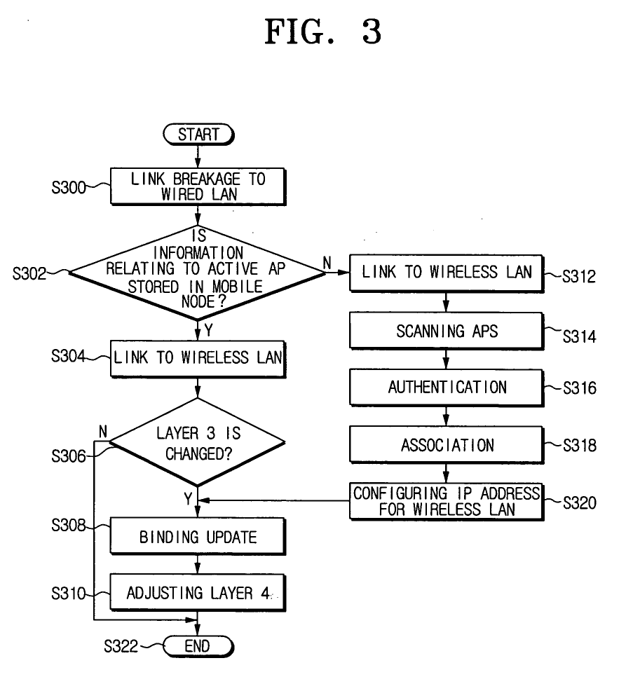

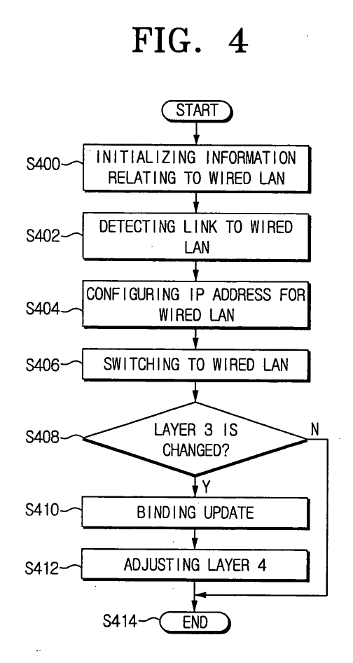

FIG. 2 illustrates operations carried out at an initial phase by a mobile node 110 that includes a wired interface for the wired LAN and a wireless interface for the wireless LAN according to an embodiment of the present invention. In short, operations of the mobile node 110 before handover are illustrated in FIG. 2. Handover operations of the mobile node 110 will be described below with reference to FIGS. 3 and 4.

The mobile node 110 scans access points (APs) in the wireless LAN (S200). The mobile node 110 searches neighbor APs through the scanning, and measures a communication state in relation to the searched APs. That is, the mobile node 110 measures a received power of data received from the APs. The delivered data contains information relating to a transmitted power. Table 1 shows a transmitted power, a received power, and a ratio of the received power to the transmitted power with respect to the data received from the APs. A unit of the measured power is mW.

TABLE 1

| | | | Received power/ |
|---|---|---|---|
| AP | Transmitted power | Received power | Transmitted power |
| AP1 | 10 | 5 | 0.500 |
| AP2 | 14 | 6 | 0.429 |
| . | . | . | . |
| . | . | . | . |
| . | . | . | . |
| APn | 12 | 4 | 0.333 |

Alternatively, the AP can transmit data with the same transmitted power. In this situation, the mobile node 110 measures the received power of the received data. Table 2 shows the received power of the data from the APs, which is measured at the mobile node 110. For example, suppose that the APs transmit data with the transmitted power of 10 mW.

TABLE 2

| AP | Received power |
|---|---|
| AP1 | 5.00 |
| AP2 | 4.29 |
| . | . |
| . | . |
| . | . |
| APn | 3.33 |

The mobile node 110 determines whether there is a target AP (S202). The target AP is an AP with the most qualified communication state among the APs scanned in operation S200. For example, given that the mobile node 110 determines the target AP based on the ratio of the received power to the transmitted power, or the received power, an AP having the largest ratio or the greatest received power can be designated as the target AP. Also, the mobile node 110 can exclude a certain AP from the target AP if the certain AP has the power ratio or the received power less than a threshold even though the power ratio or the received power is the largest value.

For example, if a threshold is 0.6 with respect to the ratio of the received power to the transmitted power, the mobile node 110 excludes AP1 through APn from the target AP. In another example, if the threshold is 0.45 with respect to the ratio of the received power to the transmitted power, the mobile node 110 designates the AP1 as the target AP. The mobile node 110 proceeds to operation S204 if the target AP is present, or the mobile node 110 proceeds to operation S210 if the target AP is absent. The mobile node 110 updates the target AP by scanning the APs in the wireless LAN at predetermined time intervals set by a user. Alternatively, the mobile node 110 can scan the APs in the wireless LAN if the ratio of the received power to the transmitted power or the received power of the target AP measured at the predetermined time intervals, falls below a threshold.

The mobile node 110 informs its upper layer of the absence of the AP operable to communicate over the wireless LAN (S210), and carries out operations for communications in the wired LAN from operation S212.

The mobile node 110 operates to convert the target AP to an active AP. The mobile node 110 authenticates the target AP to transmit and receive data with the target AP in the service area of the target AP (S204). Specifically, the mobile node 110 conducts the authentication for the target AP by querying security information and receiving a response to the query to and from an authentication server.

The mobile node 110 performs association with the target AP (S206). Thus, the mobile node 110 can transmit and receive data by way of the target AP during the association. The mobile node 110 configures an Internet protocol (IP) address for the wireless LAN (S208). The mobile node 110 transmits requested data to a foreign network over the wireless LAN, or receives required message from the foreign network by means of the IP address. After completing operation S208, the mobile node 110 can transmit and receive data over the wireless LAN. Next, the mobile node 110 conducts operations for transmitting and receiving data over the wired LAN.

The mobile node 110 initializes information relating to the wired LAN (S212), and configures an IP address for the wired LAN (S214). Hence, the mobile node 110 transmits requested data or receives required data to and from a foreign network over the wired LAN.

By carrying out operations as shown in FIG. 2, the mobile node 110 is able to transmit and receive data over both the wired LAN and the wireless LAN. When both LANs are available, the mobile node 110 prefers the wired LAN for the data transmission and reception. This is because the data transmission and reception over the wired LAN has advantages in light of data reliability and power consumption rather than the wireless LAN.

Although only one target AP is described in operation S202 of FIG. 2, any APs having the ratio of the received power to the transmitted power or the received power greater than a threshold can be the target AP according to the user's setup. A plurality of target APs can cope with a situation when one of operations S204 through S208 fails with one AP designated as the target AP. In other words, if one of the target APs fails, another target AP can carry out operations S204 through S208.

As explained in more detail below, the mobile node 110 can be handed from the service area 100 of the wired LAN to the service area 102 of the wireless LAN in reference to FIG. 3.

The mobile node 110 loses the link to the wired LAN (S300). The link breaks down when a user, who transmits and receives required data over the wired LAN, wants to move to another place, and thus unplugs a connector from the wired LAN. In addition, the link to the wired LAN may break down at the mobile node 110 due to errors in the wired LAN. Typically, it is the user who removes the link to the wired LAN, and thus, the mobile node 110 cannot perceive breakdown of the link to the wired LAN in advance.

The mobile node 110 determines whether information relating to an active AP is stored in the mobile node 110 (S302). A target AP becomes an active AP through operations S204 through S208 of FIG. 2. If the information regarding the active AP is stored in the mobile node 110 in memory, the mobile node 110 proceeds to operation S304. Otherwise, the mobile node proceeds to operation S312.

The mobile node 110 connects to the wireless LAN by use of the stored information relating to an active AP (S304). More specifically, the mobile node 110 accesses the active AP using the information relating to the active AP in order to move into the service area of the active AP. The mobile node 110 determines whether a layer 3 (CoA) is changed (S306). Upon connected to a foreign network, the mobile node 110 is assigned a care-of address (CoA) as a temporary address from the foreign network. The CoA enables the mobile node 110 to communicate with the foreign network. The mobile node 110 informs the foreign network of its movement into the foreign network by transmitting and receiving an agent advertisement message and an agent solicitation message, and sends its IP address. Upon receiving the IP address from the mobile node 110, the foreign network assigns the mobile node 110 a CoA to be used in the foreign network. Accordingly, the mobile node 110 is assigned not fixed but variable CoA.

If the layer 3 is changed, the mobile node 110 proceeds to operation S308. The mobile node 110 updates binding (S308). The binding update registers the changed CoA to the foreign network using Internet Protocol Security (IPSec).

The mobile node 110 adjusts a layer 4 if it is required (S310). For example, the mobile node 110 adjusts Transmission Control Protocol (TCP) and User Datagram Protocol (UDP). Therefore, the mobile node 110 can communicate with the foreign network over the wireless LAN.

If the layer 3 is not changed (S306), the mobile node 110 transmits and receives required data using the assigned CoA (S322).

As operations S312 through S320 are the same as operations S200 through S208 of FIG. 2, those operations are not explained for brevity. After operation S320, the mobile node transmits the configured IP address and receives a CoA from the foreign network. The handover from the wired LAN to the wireless LAN is the semi-soft handover as shown in FIG. 3. In detail, the mobile node 110 completes operations of FIG. 2, and then is handed from the wired LAN to the wireless LAN through the semi-soft handover.

FIG. 4 illustrates handover operations at the mobile node 110 from the service area 102 of the wireless LAN to the service area 100 of the wired LAN. The mobile node 110 receives a beacon from the active AP to maintain the link to the wireless LAN.

The mobile node 110, keeping the link to the wireless LAN, initializes information relating to the wired LAN (S400). The mobile node 110 detects connection to the wired LAN (S402). When the user plugs in a connector of the wired LAN to the mobile node 110, the mobile node 110 can detect the connection with the wired LAN.

The mobile node 110 configures an IP address for the wired LAN (S404), and switches to the wired LAN (S406). The mobile node 110 determines whether the layer 3 (CoA) is changed (S408). The mobile node 110 sends its configured IP address to the foreign network, and determines whether a care-of address (CoA) assigned from the foreign network is identical with the CoA used in the wireless LAN. If the CoA change is determined, the mobile node 110 proceeds to operation S410. Otherwise, the mobile node 110 communicates with the foreign network over the wired LAN (S414).

The mobile node 110 updates binding (S410). As mentioned above, the binding update registers the changed CoA to the foreign network by means of IPSec. The mobile node 110 adjusts the layer 4 if necessary (S412). For example, the mobile node 110 adjusts TCP and UDP.

As shown in FIG. 4, the mobile node 110 is handed from the wireless LAN to the wired LAN through the soft handover. That is, the mobile node 110 establishes the link to the wired LAN with the link to the wireless LAN maintained.

In light of the foregoing as aforementioned, the mobile node can be handed between the service areas of the wired LAN and the wireless LAN according to exemplary embodiments of the present invention. As the mobile node moves from the service area of the wired LAN to that of the wireless LAN according to the semi-soft handover, data interruption time can be minimized and radio resources are not wasted unnecessarily. In addition, as the mobile node moves from the service area of the wireless LAN to that of the wired LAN according to the soft handover, the seamless handover can be carried out without data interruption.

In addition, the handover service methods according to exemplary embodiments of the present invention may be written as instructions, a computer program or programs, or code segments that are executed in any computer or computing device such as a mobile node, wired network, or wireless network. The instructions, computer program(s), or code segments may be stored in a computer-readable data storage medium so that it is read and executed by any computer or computing device. Examples of computer-readable data storage medium include a magnetic recording medium (e.g., a ROM, a floppy disk, a hard disk, etc.), an optical recording medium (e.g., a CD-ROM, DVD, etc.), and a carrier wave medium or digital transmission medium (e.g., data transmission through the Internet, wireless network, or wired network). Examples of the computer-readable data storage medium further include any type of transmission medium including networks, which may be wired networks, wireless networks, or any combination thereof. The computer-readable data storage medium may be referred to as a medium, and the medium may be distributed among computers or computing devices as part of one or more networks or coupled with one or more networks.

While the present invention has been particularly shown and described with reference to exemplary embodiments thereof, it will be understood by those skilled in the art that various changes in form and details may be made therein without departing from the principles and spirit of the invention, the scope of which is defined in the claims and their equivalents.

1. A handover method of a mobile node that moves from a service area of a wired local area network (LAN) to a service area of a wireless LAN, comprising:
accessing an active access point (AP) using information relating to the active AP stored in the mobile node when breakage of a link to the wired LAN is detected; and
communicating with the active AP using a temporary address assigned from the connected active AP.

2. The handover method of claim 1, wherein the mobile node configures and stores an Internet protocol (IP) address, which is used to access the active AP.

3. The handover method of claim 1, further comprising updating binding when the assigned temporary address is different from another temporary address used in the wired LAN.

4. The handover method of claim 1, wherein the active AP, among APs in the wireless LAN, has a communication state, which is determined to be qualified by the mobile node.

5. The handover method of claim 4, wherein the communication state is measured by at least one of a ratio of a received power to a transmitted power, and the received power to determine that the communication state qualifies as the active AP.

6. The handover method of claim 4, wherein the mobile node measures a communication state of the APs in the wireless LAN when the communication state of the active AP, which is measured at predetermined time intervals, falls below a threshold and disqualifies the active AP.

7. The handover method of claim 1, wherein the mobile node is handed from the service area of the wired LAN to the service area of the wireless LAN according to a semi-soft handover.

8. A handover method of a mobile node that moves from a service area of a wireless local area network (LAN) to a service area of a wired LAN, comprising:
configuring an Internet protocol (IP) address for the wired LAN when the mobile node, keeping a link to an active access point (AP), detects connection to the wired LAN; and
communicating over the wired LAN using an assigned temporary address corresponding to the IP address.

9. The handover method of claim 8, wherein the mobile node is handed from the service area of the wireless LAN to the service area of the wired LAN according to a soft handover.

10. The handover method of claim 8, further comprising updating binding when the assigned temporary address is different from a temporary address used in the wireless LAN.

11. The handover method of claim 8, wherein the mobile node is assigned a temporary address using a pre-configured IP address for the wired LAN when a link to the wired LAN is detected.

12. A handover method of a mobile node that moves between a service area of a wireless local area network (LAN) and a service area of a wired LAN, comprising:
determining whether the handover is requested; and
moving, when the handover is requested, to the service area of the wired LAN according to a soft handover when a current service area is the service area of the wireless LAN, and moving to the service area of the wireless LAN according to a semi-soft handover when the current service area is the service area of the wired LAN.

13. The handover method of claim 12, wherein the soft handover comprises:
configuring an Internet protocol (IP) address for the wired LAN when the mobile node, keeping a link to an active access point (AP), detects connection to the wired LAN; and
communicating over the wired LAN using an assigned temporary address corresponding to the IP address.

14. The handover method of claim 12, wherein the semi-soft handover comprises:
accessing an active AP when breakage of a link to the wired LAN is detected using information relating to the active AP stored in the mobile node; and
communicating with the active AP using a temporary address assigned from the connected active AP.

15. At least one computer readable medium storing instructions that control at least one processor to perform a handover method of a mobile node that moves from a service area of a wired local area network (LAN) to a service area of a wireless LAN, comprising:
accessing an active access point (AP) using information relating to the active AP stored in the mobile node when breakage of a link to the wired LAN is detected; and
communicating with the active AP using a temporary address assigned from the connected active AP.

16. At least one computer readable medium storing instructions that control at least one processor to perform a handover method of a mobile node that moves from a service area of a wireless local area network (LAN) to a service area of a wired LAN, comprising:
configuring an Internet Protocol (IP) address for the wired LAN, when the mobile node keeping a link to an active access point (AP), detects connection to the wired LAN; and
communicating over the wired LAN using an assigned temporary address corresponding to the IP address.

17. At least one computer readable medium storing instructions that control at least one processor to perform a handover method of a mobile node that moves between a service area of a wireless local area network (LAN) and a service area of a wired LAN, comprising:
determining whether the handover is requested; and
moving, when the handover is requested, to the service area of the wired LAN according to a soft handover when a current service area is the service area of the wireless LAN, and moving to the service area of the wireless LAN according to a semi-soft handover when the current service area is the service area of the wired LAN.

18. The at least one computer readable medium of claim 17, wherein the soft handover comprises:
configuring an Internet protocol (IP) address for the wired LAN when the mobile node, keeping a link to an active access point (AP), detects connection to the wired LAN; and
communicating over the wired LAN using an assigned temporary address corresponding to the IP address.

19. The at least one computer readable medium of claim 17, wherein the semi-soft handover comprises:
accessing an active AP, which is stored in the mobile node, when breakage of a link to the wired LAN is detected; and
communicating with the active AP using a temporary address assigned from the connected active AP.

20. The at least one computer readable medium of claim 19, wherein the active AP is in a communication state which is qualified by the mobile node.
